(19) United States
(12) Patent Application Publication
(10) Pub. No.: US 2007/0230962 A1
(43) Pub. Date: Oct. 4, 2007

(54) Device Recognition Method

(75) Inventors: Matthew T. Fisher, Reno, NV (US); Timothy M. Simon, San Francisco, CA (US); Blaine M. Smith, Portland, OR (US)

Correspondence Address: HAYNES BEFFEL & WOLFELD LLP, P O BOX 366, HALF MOON BAY, CA, 94019, US

(73) Assignee: Tim Simon, Inc., San Francisco, CA (US)

(21) Appl. No.: 11/692,827

(22) Filed: Mar. 28, 2007

Related U.S. Application Data
(60) Provisional application No. 60/743,921, filed on Mar. 29, 2006.

(51) Int. Cl. H04B 10/00

(52) U.S. Cl. 398/106

(57) ABSTRACT

In one example first and second remotely communicating devices (RCDs) are physically mated and handshake information is transferred to allow the first RCD to recognize signals from the second RCD. The RCDs are physically separated and signals from the second RCD are recognized by the first RCD. In some examples the physically mating step is carried out using magnetic materials. In some examples the handshake information is transferred wirelessly. In another example an actuator device is physically mated with a first RCD causing the first RCD to enter a first device recognition state for a first period of time. The actuator device is physically separated from the first RCD. A second RCD is mated with an actuator device within the first period of time causing the second RCD to enter a second device recognition state to permit handshake information to be remotely transferred between the RCDs thereby enabling the first RCD to recognize signals from the second RCD.

### CROSS-REFERENCE TO OTHER APPLICATIONS

This application claims the benefit of U.S. Provisional Patent Application No. 60/743,921 entitled Device Recognition Method filed 29 Mar. 2006, attorney docket number TIMS 1012-1.

### FEDERALLY SPONSORED RESEARCH OR DEVELOPMENT

None.

### BACKGROUND OF THE INVENTION

Home automation systems, in particular wireless home automation systems, offer a great deal of potential in terms of convenience of use, energy saving and flexibility in how they are used. One of the problems with home automation systems relates to ensuring that the various actor devices, those devices that actually perform the function such as a light switch or an HVAC relay unit, properly receive instructions from sensors and other input devices, such as motion sensors, remote controllers and thermostatic logic devices, but ignore other signals. While installation of a complete system by a trained technician familiar with the system may not create significant obstacles, other situations, such as installing unusual components or adding components to an existing system, may create substantial obstacles to proper performance, especially for a homeowner.

### BRIEF SUMMARY OF THE INVENTION

A first example of a method for device recognition includes the following. First and second remotely communicating devices (RCDs) are physically mated. This is followed by transferring handshake information between the first and second RCDs thereby enabling at least the first RCD to subsequently recognize signals from the second RCD. The first and second RCDs are physically separated. Signals from the second RCD are recognized by the first RCD. In some examples the physically mating step comprises mating at least one magnet on at least one of the first and second RCDs with a magnetic material on the other of the first and second RCDs. In some examples the handshake information can be transferred wirelessly.

A second example of a method for device recognition includes the following. An actuator device is physically mated with a first remotely communicating device (first RCD) causing the first RCD to enter a first device recognition state for a first period of time. The actuator device is physically separated from the first RCD. The same actuator device or a different actuator device is physically mated with a second RCD within the first period of time causing the second RCD to enter a second device recognition state for a second period of time. Handshake information is remotely transferred within the first period of time between the first and second RCDs thereby enabling at least the first RCD to subsequently recognize signals from the second RCD.

A third example of a method for device recognition includes the following. A first remotely communicating device (first RCD) is actuated causing the first RCD to enter a first device recognition state for a first period of time. A second RCD is actuated within the first period of time causing the second RCD to enter a second device recognition state for a second period of time. Handshake information is remotely transferred within the first period of time between the first and second RCDs thereby enabling at least the first RCD to subsequently recognize signals from the second RCD. Signals from the second RCD are recognized by the first RCD. In some examples the first actuating step is carried out by actuating a button on the first RCD.

Other features, aspects and advantages of the present invention can be seen on review the Figs., the detailed description, and the claims which follow.

### BRIEF DESCRIPTION OF THE DRAWINGS

FIG. 1 is a simplified, schematic view of two remotely communicating devices being physically mated with one another to permit handshake information to be transferred;

FIG. 2 illustrates an example of the remotely communicating devices of FIG. 1, specifically a remote control mated to a light switch;

FIG. 3 is a schematic diagram of portions of the remotely communicating devices of FIG. 2 illustrating the actuation circuits;

FIG. 4 shows another example of a remotely communicating device in the form of an appliance switch together with the light switch and remote control of FIG. 2;

FIG. 5 shows a further example including a motion sensor mounted to the door of a mailbox and a remote announcer;

FIG. 6 is a schematic diagram showing a simple virtual thermostat comprising remotely communicating devices mateable with one another;

FIG. 7 shows another example in which two or more remotely coupled remotely communicating devices are mated with a key, after which the recently activated devices look for another recently activated device to exchange handshake information with; and

FIG. 8 is a view of a remotely coupled remotely communicating device similar to that of FIG. 7 but modified to eliminate the need for a key.

### DETAILED DESCRIPTION OF THE INVENTION

The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Like elements in various embodiments are commonly referred to with like reference numerals.

This application often refers to home automation systems because it is a typical type of installation. However, the invention is not so limited but can be used in commercial and industrial installations as well. Also, the invention is often described in terms of using an RF wireless signal using the Zigbee protocol. In appropriate cases, a Zigbee repeater may be used to ensure a high-quality signal between the devices. Other types of wireless protocols can be used for the devices and repeaters.

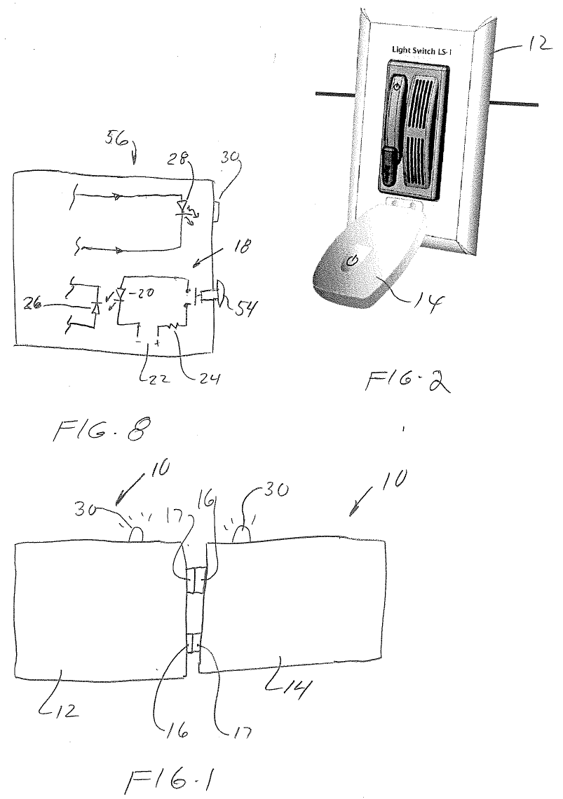

FIGS. 1, 2 and 3 illustrate two remotely communicating devices 10, sometimes called RCDs, in particular a light switch 12 and a remote control 14. Each RCD 10 has a pair of magnetic electric contacts 16, 17 oriented and spaced so that remote control 14 can be placed adjacent to light switch 12 with magnetic electric contacts 16, 17 opposite one another. Contacts 16, 17 help draw the two components together and provide the user a positive indication that the devices have been properly mated in an extremely simple, visual, tactile and auditory way. That is, the user feels remote control 14 being pulled to light switch 12 and typically hears and feels, and sometimes sees, the contact of magnetic electric contacts 16, 17.

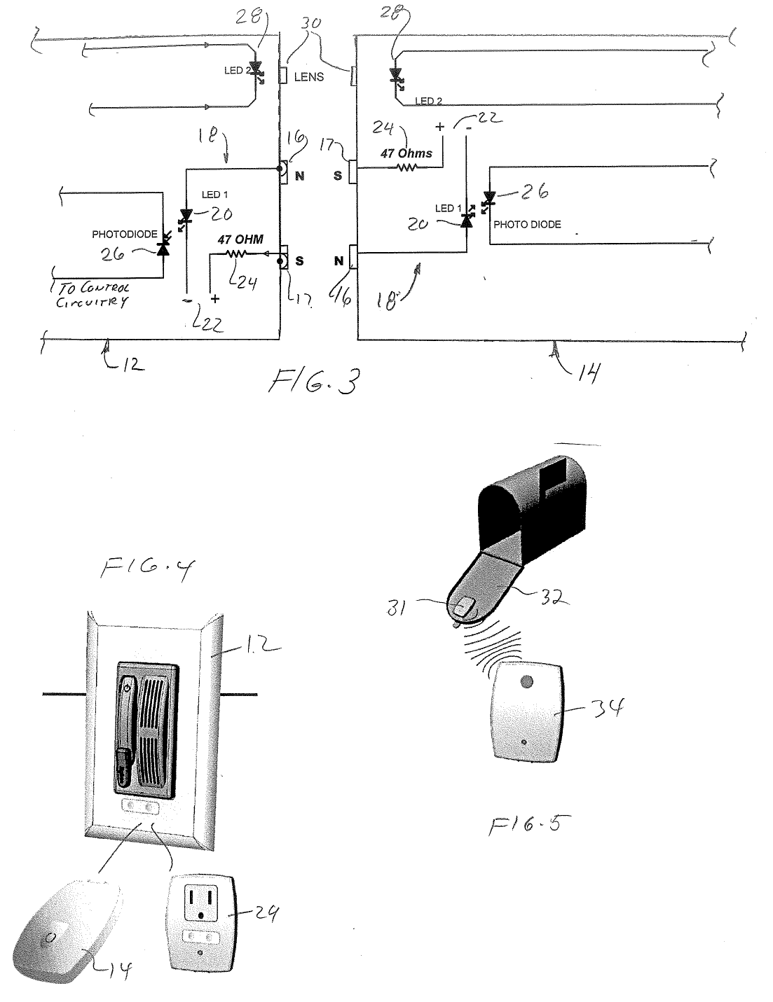

An example of the magnetic mating components for two RCDs, such as light switch 12 and remote control 14, is illustrated in FIG. 3. Light switch 12 is seen to include North and South magnetic electrical contacts 16, 17 connected to an actuation circuit 18 including a first LED 20, a power source 22 and a current limiting resistor 24. Remote control 14 includes a similar actuation circuit 18 but with North and South magnetic electrical contacts 16, 17 reversed. Only when magnetic electrical contacts 16, 17 of light switch 12 contact magnetic electrical contacts 17, 16 of remote control 14 are circuits 18 in the two devices completed causing current to flow through first LEDs 20. The illumination of first LEDs 20 is sensed by photodiodes 26 to activate their respective control circuitry. The spacing between an LED 20 and photodiodes 26 provides protection to the control circuitry from electrostatic discharge, which can be created during the mating of RCDs 10.

In this example the control circuitry transfers handshake information between the two devices causing the two devices to recognize one another. This recognition causes the RCDs to bind or couple so that the two RCDs interact in a predetermined way. With light switch 12 and remote control 14, any future actuation of remote control 14 will cause light switch 12 to, typically, turn off, turn on or dim. It is preferred that the user need do nothing, or at most simply press a switch, after the two devices are mated to cause the transfer of handshake information. In some examples the transfer of handshake information is through remote communication, typically carried out using RF wireless signals. In some examples this wireless transfer of handshake information is carried out using a Zigbee protocol or a modified Zigbee protocol. Other wireless communication protocols can also be used.

Zigbee is the name of a specification for a suite of high level communication protocols using small, low-power digital radios based on the IEEE 802.15.4 standard for wireless personal area networks (WPANs). The relationship between IEEE 802.15.4-2003 and Zigbee is similar to that between IEEE 802.11 and the Wi-Fi Alliance. The Zigbee 1.0 specification was ratified on December 14, 2004 and is available to members of the Zigbee Alliance. Zigbee operates in the industrial, scientific and medical (ISM) radio bands; 868 MHz in Europe, 915 MHz in the USA and 2.4 GHz in most jurisdictions worldwide. Additional information on the Zigbee protocol can be found at www.Zigbee.org. An example of a modified Zigbee protocol is disclosed in U.S. Provisional Patent Application No. 60/888,681 filed 7 Feb. 2007, the disclosure of which is incorporated by reference.

The transfer of the handshake information can be carried out while magnetic electrical contacts 16, 17 are electrically connected to one another or after light switch 12 and remote control 14 have been separated. In other examples transfer of the handshake information can be through a hardwired connection between first and second RCDs 12, 14, such as through contacts 16, 17 or otherwise, while the RCDs are physically mated.

Light switch 12 and remote control 14 may each also include an indicator LED 28 adjacent to a lens 30 to provide a signal to a user during and/or after the handshake information transferring step that data transfer is being and/or has been accomplished. For example, LEDs 28 may blink during the transfer but become constantly illuminated for a period of time after the transfer.

After the physical mating of light switch 12 and remote control 14 and the transfer of handshake information, light switch 12 can be controlled by remote control 14 in a conventional fashion. In some examples remote control 14 can be used to control additional RCDs, such as another light switch 12 or an appliance switch 29 as shown in FIG. 4. Remote control 14 can be physically mated with appliance switch 29 in the same manner as with light switch 12. In some examples actuation of remote control 14 would actuate both light switch 12 and appliance switch 29. In other examples, appliance switch 29 could be mated to light switch 12 instead of remote control 14 so that appliance switch 29 would be controlled by light switch 12 and typically would be actuated whenever light switch 12 has been actuated, whether or not the light switch was actuated using remote control 14. In other examples each device 12, 14, 29 can be mated with the other two devices to permit, for example, signals from remote control 14 to be recognized by light switch 12 and by appliance switch 29, signals from light switch 12 to be recognized by appliance switch 29, and signals from appliance switch 29 to be recognized by light switch 12.

To clear an RCD of any coupling to another RCD, the RCD would typically include a reset button, not shown.

In another example, see FIG. 5, the first and second RCDs include a motion sensor 31 mounted to, for example, the door 32 of a mailbox. A remote announcer 34 can be mated with motion sensor 31 to provide a signal, typically a sound and a blinking light, that the door of the mailbox has been opened indicating a mail delivery.

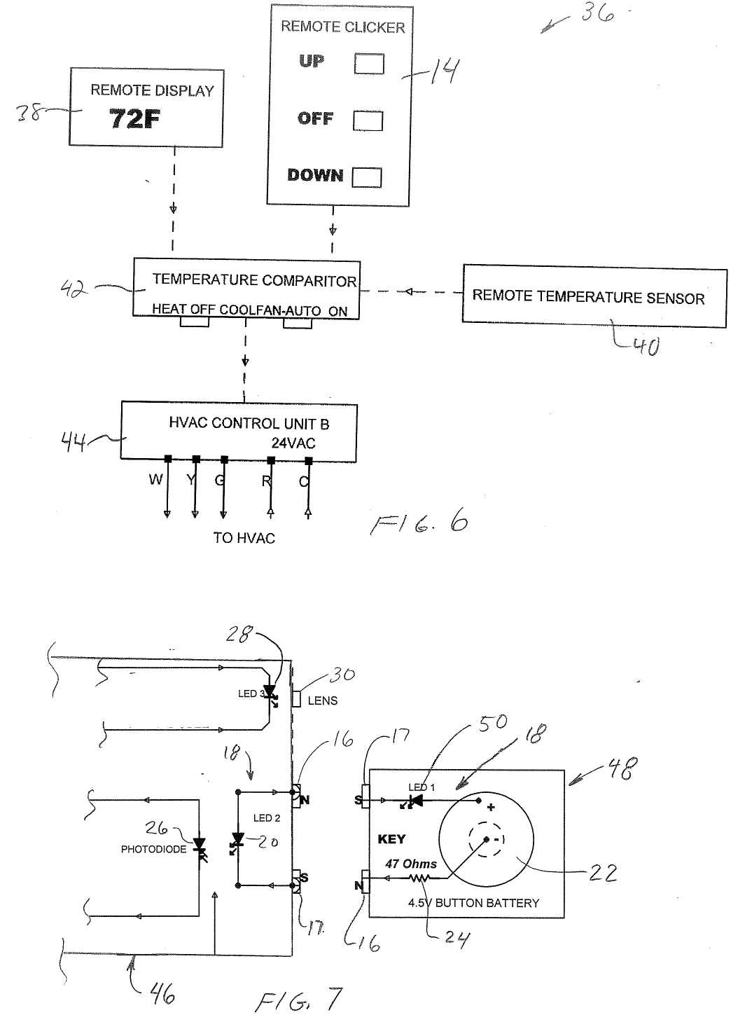

FIG. 6 is a drawing of an exemplary simple virtual thermostat 36 using building block components. The arrows along the dashed lines between the components indicate the mating association. That is, remote control 14, a remote temperature display 38 and a remote temperature sensor 40 are each mated to a temperature comparator 42. Temperature comparator 42 can be placed in an inconspicuous location, such as in a closet. Temperature comparator 42 is mated with an HVAC control unit 44 which may be located at the site of the HVAC equipment (typically a furnace unit) or on a wall in place of a thermostat. Remote temperature sensor 40 can be used with, for example, a conventional thermostat in the house or outside. Remote temperature display 3 8 can be associated with a thermostat in a main living area or a different area, such as an out building or a different room in the building. HVAC control unit 44 can be used to control other devices or systems, such as watering valves or outside lights, in addition to or instead of an HVAC unit.

Another, remotely coupled example of an RCD will be discussed with reference to FIG. 7. In this example a remotely coupled RCD, such as light switch 46, is mated not with another RCD but rather with a device actuator or key 48. After mating with light switch 46, key 48 is used to remotely mate with an additional RCD, such as a remotely coupled remote control (not shown). After mating, the control circuitry of light switch 46 and the remotely coupled remote control each become active for a period of time, such as two minutes, sometimes referred to as the search period. During this search period the recently activated RCDs search for another recently activated RCD to exchange handshake with information with. According to this example is not necessary to physically mate RCDs, some of which may be in another room or mounted to a wall, to have them exchange handshake information and thus become bound or coupled. Using key 48 and remotely coupled RCDs in the example of FIG. 6 makes coupling the RCDs much easier than physically mating each RCD with another RCD. If, for example, it is desired to have light switch 46 communicate with another remotely coupled RCD, such as a remotely coupled RCD associated with a front doorbell, the process would be repeated for light switch 46 and the front doorbell RCD using key 48. In this example light switch 46 would operate, typically to control an associated light, when the remote control or the front doorbell is operated.

Key 48 includes an actuator circuit 18 similar to the actuator circuit 18 of the RCDs discussed above with reference to FIG. 3 but also including an indicator LED 50 which indicates whenever circuit 18 is closed, thus indicating mating with light switch 46 or another RCD. Appropriate visual indications of the search period and of successful mating can be provided by indicator LEDs 28, 50.

Additional circuitry could be used with key 48 so that indicator LED 50, or an additional LED, a digital readout or another indicator, could provide the user with an indication of the status of the search period for the first RCD, light switch 46 in the FIG. 7 example. For example, indicator LED 50 could be controlled to continuously illuminate while it is mated to an RCD, blink slowly during most of the search period for the first-mated RCD and began blinking rapidly during the last, for example, 10 seconds of the search period. Providing such an indication would help the user complete the binding or coupling of the RCDs before the search period for the first-mated RCD times out. This additional status indication would not be available if different keys 48 are used for each RCD.

Although actuator circuit 18 of light switch 12 in FIG. 7 could be the same as in FIG. 3, it need not be the same. It can be a simplified version as shown in FIG. 7 which eliminates battery 22 and current limiting resistor 24 as those functions are provided by actuator circuit 18 of key 48. However, if it is desired to have the flexibility of allowing the RCDs of FIGS. 3 and 7 to mate with one another and to mate remotely using key 48, it may be necessary or desirable to use, for example, actuator circuit 18 of FIG. 3 with the RCDs.

FIG. 8 discloses a further example of a remotely coupled RCD, such as a light switch 56. Magnetic electric contacts 16, 17 have been replaced by an actuator button 54 that when actuated closes actuation circuit 18. This eliminates the need for key 48. Otherwise, it operates similar to the FIG. 7 example.

The following is an exemplary list of devices that may be used with the present invention: bathroom fans, people sensors, thermostats, air duct baffle controls, irrigation timers, dog monitors, door latches, video sensors, moisture sensors, light sensors, motion sensors, air pressure sensors, leak sensors, window alarms, gas sensors, pumps, and RF signal repeaters.

In some examples of the device recognition system permits the user to synch and link to one or more devices through intimate contact, preferably using magnets, as (a) a mechanical means to show the user that the two or more devices are connected, and (b) as a means for transferring handshake information between or among the devices to permit appropriate signal recognition between or among the devices. The process involves having two devices connect to each other by actuating control elements on one device and on another device. The control element can include, for example, a mechanical button or a magnetic switch or magnets pulling two devices together. Some embodiments use magnets to give the user a positive indication in an extremely simple, visible, tactile and auditory way that the devices are properly connected to one another. However, other types of mating features, such as plug and socket types of connections, can also be used.

The above descriptions may have used terms such as above, below, top, bottom, over, under, et cetera. These terms are used to aid understanding of the invention are not used in a limiting sense.

While the present invention is disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the invention and the scope of the following claims. For example, a security lock could be incorporated into RCDs 10 to control who can clear an RCD of any coupling to another RCD and to control who can cause an RCD to become bound or coupled to another RCD.

Any and all patents, patent applications and printed publications referred to above are incorporated by reference.

What is claimed is

1. A method for device recognition comprising:
physically mating first and second remotely communicating devices (RCDs) followed by:
transferring handshake information between the first and second RCDs thereby enabling at least the first RCD to subsequently recognize signals from the second RCD;
physically separating the first and second RCDs; and
recognizing signals from the second RCD by the first RCD.

2. The method according to claim 1 wherein the physically mating step comprises mating at least one magnet on at least one of the first and second RCDs with a magnetic material on the other of the first and second RCDs.

3. The method according to claim 2 wherein the at least one magnet mating step comprise contacting a magnet on the first RCD with a magnet on the second RCD.

4. The method according to claim 3 wherein the magnet contacting step comprises creating an electric circuit through the magnets on the first and second RCDs.

5. The method according to claim 1 wherein the physically mating step comprises creating an electric circuit between the first and second RCDs.

6. The method according to claim 1 wherein the physically separating step is carried out after the handshake information transferring step.

7. The method according to claim 1 wherein the handshake information transferring step comprises wirelessly transferring the handshake information.

8. The method according to claim 1 wherein the handshake information transferring step enables the second RCD to subsequently recognize signals from the first RCD, and wherein the signals recognizing step further comprises recognizing signals from the first RCD by the second RCD.

9. The method according to claim 1 further comprising:
physically mating a third RCD with at least one of the first and second RCDs followed by:
remotely transferring handshake information between the third RCD and at least one of the first and second RCDs thereby enabling:
at least one of the first and second RCDs to subsequently recognize signals from the third RCD; or
the third RCD to subsequently recognize signals from at least one of the first and second RCDs; or
at least one of the first and second RCDs to subsequently recognize signals from the third RCD, and the third RCD to subsequently recognize signals from at least one of the first and second RCDs;
physically separating the third RCD from the at least one of the first and second RCDs; and
recognizing signals by:
at least one of the first and second RCDs from the third RCD; or
the third RCD from at least one of the first and second RCDs; or
at least one of the first and second RCDs from the third RCD, and the third RCD from at least one of the first and second RCDs.

10. The method according to claim 1 further comprising providing a signal to a user during the handshake information transferring step.

11. The method according to claim 1 where on the physically mating step comprises providing the user a visual, tactile and auditory indication that the devices are properly connected to one another.

12. A method for device recognition comprising:
physically mating an actuator device with a first remotely communicating device (first RCD) causing the first RCD to enter a first device recognition state for a first period of time;
physically separating the actuator device from the first RCD;
physically mating the same actuator device or a different actuator device with a second RCD within the first period of time causing the second RCD to enter a second device recognition state for a second period of time;
remotely transferring handshake information within the first period of time between the first and second RCDs thereby enabling at least the first RCD to subsequently recognize signals from the second RCD; and
recognizing signals from the second RCD by the first RCD.

13. The method according to claim 12 wherein the first RCD transmits a first device recognition signal during the first device recognition state.

14. The method according to claim 12 wherein the second RCD transmits a second device recognition signal during the second device recognition state.

15. The method according to claim 12 wherein the first RCD physically mating step comprises mating at least one magnet on at least one of the actuator device and the first RCD with a magnetic material on the other of the actuator device and the first RCD.

16. The method according to claim 15 wherein the at least one magnet mating step comprises contacting a magnet on the actuator device with a magnet on the first RCD.

17. The method according to claim 12 wherein the first RCD physically mating step comprises creating an electric circuit between the actuator device and the first RCD.

18. The method according to claim 12 physically separating the second RCD from the same or different actuator device after the handshake information transferring step.

19. The method according to claim 12 wherein the signals recognizing step further comprises recognizing signals from the first RCD by the second RCD.

20. The method according to claim 12 further comprising:
physically mating the same actuator device or a different actuator device with a third RCD within at least one of the first and second periods of time causing the third RCD to enter a third device recognition state for a third period of time;
remotely transferring handshake information within at least one of the first and second periods of time between the third RCD and at least one of the first and second RCDs thereby enabling:
at least one of the first and second RCDs to subsequently recognize signals from the third RCD; or
the third RCD to subsequently recognize signals from at least one of the first and second RCDs; or
at least one of the first and second RCDs to subsequently recognize signals from the third RCD, and the third RCD to subsequently recognize signals from at least one of the first and second RCDs; and
recognizing signals by:
at least one of the first and second RCDs from the third RCD; or
the third RCD from at least one of the first and second RCDs; or
at least one of the first and second RCDs from the third RCD, and the third RCD from at least one of the first and second RCDs.

21. The method according to claim 20 further comprising physically separating the same or different actuator device from the third RCD.

22. The method according to claim 12 further comprising providing a first signal to a user while the first RCD is in the first device recognition state and providing a second signal to the user while the second RCD is in the second device recognition state.

23. The method according to claim 12 further comprising providing a first visual signal to a user by the first RCD while the first RCD is in the first device recognition state and providing a second visual signal to the user by the second RCD while the second RCD is in the second device recognition state.

24. The method according to claim 12 wherein the physically mating steps comprise providing the user a visual, tactile and auditory indication that the devices are properly connected to one another.

25. A method for device recognition comprising:
actuating a first remotely communicating device (first RCD) causing the first RCD to enter a first device recognition state for a first period of time;
actuating a second RCD within the first period of time causing the second RCD to enter a second device recognition state for a second period of time;
remotely transferring handshake information within the first period of time between the first and second RCDs thereby enabling at least the first RCD to subsequently recognize signals from the second RCD; and
recognizing signals from the second RCD by the first RCD.

26. The method according to claim 25 wherein the first actuating step is carried out by actuating a button on the first RCD.
